(19) United States
(12) Patent Application Publication
(10) Pub. No.: US 2009/0003309 A1
(43) Pub. Date: Jan. 1, 2009

(54) CAPABILITY OR ROLE-BASED ROUTING

(75) Inventors: Anthony J. Bawcutt, Kirkland, WA (US); Scott C. Forbes, Redmond, WA (US); Kalyan Basu, Sammamish, WA (US); Jeremy T. Buch, Louisville, CO (US); Anoop Gupta, Woodinville, WA (US); Warren Vincent Barkley, Mill Creek, WA (US); Ross Cutler, Redmond, WA (US); Timothy M. Moore, Bellevue, WA (US); Michael Trommsdorff, Zuerich (CH)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/770,863

(22) Filed: Jun. 29, 2007

(51) Int. Cl. H04L 12/28; G06F 15/16; H04Q 7/28

(52) U.S. Cl. 370/351; 370/241; 370/254; 370/354; 370/431; 709/238

(57) ABSTRACT

The claimed subject matter provides a system and/or a method that facilitates enhancing incoming data communication connectivity within a network. An analyzer component can evaluate a portion of an incoming data communication targeted for a network to identify a context associated with the data communication. A transfer component can direct the incoming data communication to a cluster within the network based at least in part upon the identified context, wherein the cluster includes a physical entity with pre-existing knowledge of the identified context.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, people in general tend to be more and more concerned about maximizing their ability to communicate using cell phone calls, text messages, emails, instant messages, land line phone calls, voice mails, etc. In addition, the non-stop, fast-paced mentality of today's society demands responsiveness and if not provided, impatience and dissatisfaction sets in. Such responsiveness can be crucial to businesses, companies, enterprises, etc. in order to provide superior customer satisfaction since customer satisfaction plays a significant role in a fruitful business venture. For example, a company who handles incoming customer communications in an efficient and prompt manner will have an excellent reputation which can yield high customer return, customer recommendations, and overall positive ratings from customers. For companies who do not strive to satisfy customers, such characteristic can be detrimental to business and success. Thus, providing customer care in prompt and efficient manner can be a very good barometer in determining the potential success or failure of a company, business, enterprise, etc.

In general, many companies have opened numerous data communication modes/channels in order to accommodate customers and battle potential irritation associated with directing incoming data communications. For example, data communication modes can include, but are not limited to, electronic mail (email), Internet Protocol (IP) telephony, web mail, web-browsing, text messaging, etc. Yet, with all the available data communication modes and technological advances that can be leveraged, issues still surround the ability to contact the intended recipient of the communication. In other words, a company, business, enterprise, etc. can have a website, a phone number, an email contact, a cell number, a contact individual, etc., yet most incoming data communications will require additional transferring, routing, connecting, directing, etc. As discussed, customers can be easily agitated during such processes.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate directing an incoming data communication to an entity related to the context of the incoming data communication. An analyzer component can receive a portion of an incoming data communication in order to identify a context and/or a topic associated therewith. The analyzer component can ascertain the context and/or topic of the incoming data communication by analyzing any suitable portion of data related to the incoming data communication, the origin of the incoming data communication, the source of the incoming data communication, the incoming data communication mode, the targeted network to which the incoming data communication is targeted, etc. Based upon such evaluation and identification of the context and/or topic, a transfer component can route the incoming data communication to a physical entity with pre-existing knowledge of the topic and/or context. By directing the incoming data communication to a physical entity with pre-existing knowledge of the context and/or topic, the incoming data communication is serviced in an optimal and efficient manner.

In accordance with an aspect of the subject innovation, an organizer component can generate a cluster including at least one physical entity based upon monitoring data associated with a network. The organizer component can identify topics and/or contexts in which a physical entity can have a pre-existing knowledge and/or understanding. The organizer component can collect data actively (e.g., questionnaires, entity definitions, etc.), passively (e.g., continuously monitor on-going data communications with the network, etc.), and/or any suitable combination thereof. The transfer component can direct the incoming communications to a physical entity with a cluster based on a correlating and/or matching context and/or topic. In other aspects of the claimed subject matter, methods are provided that facilitate transferring an incoming data communication to a cluster of individuals within a network.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates servicing incoming data communications.

FIG. 2 illustrates a block diagram of an exemplary system that facilitates directing an incoming data communication to an entity related to the context of the incoming data communication.

FIG. 3 illustrates a block diagram of an exemplary system that facilitates transferring an incoming data communication to a cluster of individuals within a network.

FIG. 4 illustrates a block diagram of an exemplary system that facilitates servicing an incoming data communication targeted for a network.

FIG. 5 illustrates a block diagram of exemplary system that facilitates linking an incoming data communication from a source to an optimal cluster of individuals that have knowledge of the data communication context.

FIG. 6 illustrates a block diagram of an exemplary system that facilitates directing incoming data communications to a knowledgeable resource/entity with efficiency, accuracy, and promptness.

FIG. 7 illustrates an exemplary methodology for servicing incoming data communications.

FIG. 8 illustrates an exemplary methodology that facilitates directing an incoming data communication to an entity related to the context of the incoming data communication.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “entity,” “network,” “cluster,” “source,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

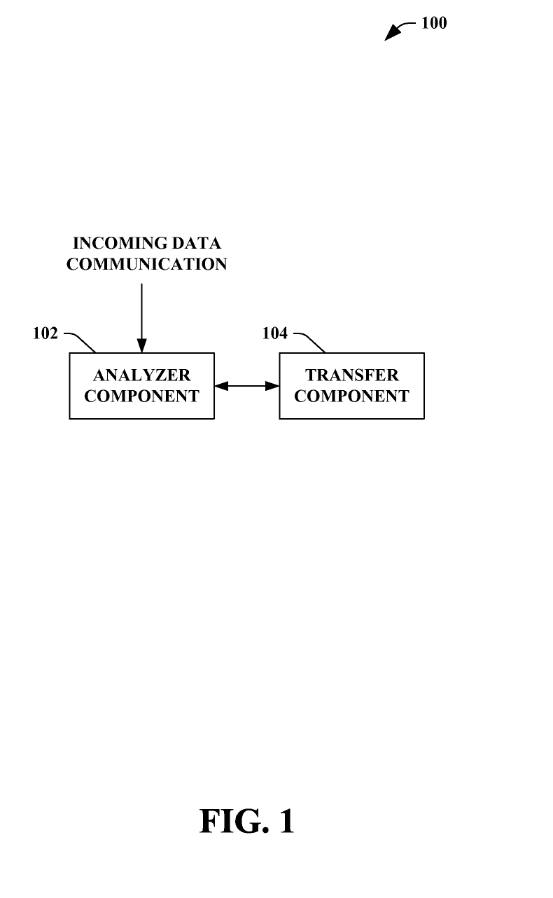

Now turning to the figures, FIG. 1 illustrates a system 100 that facilitates servicing incoming data communications. The system 100 can include an analyzer component 102 that can evaluate a portion of an incoming data communication. In general, the analyzer component 102 can evaluate the incoming data communication in order to identify a context and/or specifics related therewith. For example, an incoming data communication can be evaluated by the analyzer component 102 in order to ascertain the communication relates to a particular topic such as an inquiry related to employment opportunities. It is to be appreciated that the analyzer component 102 can evaluate any suitable data related to the incoming data communication and the incoming data can be any suitable data communication. For instance, the incoming data communication can be at least one of a cellular communication, a telephone communication, a text message, an instant message, an email, a voice mail, an audio communication, a video communication, a voice over Internet protocol (VOIP) communication, a short message service (SMS), a multimedia messaging service (MMS), a voice communication, a data transmission, an image communication, and/or any suitable incoming data communication that can be evaluated to identify a context associated therewith. In particular, a text message can be an SMS message, a MMS message, and/or any other suitable technique that transmits data via text message. It is to be appreciated that the above incoming data communications can be include overlap. For instance, a telephone communication can be a VoIP communication.

Upon identifying a context associated with the incoming data communication, the system can utilize a transfer component 104 to direct the incoming data communication based at least in part upon the identified context. In other words, the analyzer component 102 can evaluate the incoming data communication in order to identify a context, wherein the transfer component 104 can direct and/or link the incoming data communication based upon such context. The transfer component 104 can direct the incoming communication to, for instance, a physical entity that has pre-existing knowledge associated with the identified context. Since the physical entity has a pre-existing knowledge of the context and/or specifics related to the data communication, servicing such communication is greatly enhanced and/or optimized. Furthermore, the transfer component 104 can enable the incoming communication to be directed to a group and/or collection of physical entities that can handle the topic and/or context of the incoming data communication. It is to be appreciated that the analyzer component 102 can be trained by at least one of an end-user, a disparate analyzer, a portion of historic data, a local area analyzer component (not shown) on a network, an organization of analyzer components, or an intelligent component (discussed in detail below).

For example, an incoming data communication can be associated with a finance inquiry (e.g., the context of the incoming data communication is finance), wherein the analyzer component 102 can identify such context by evaluating various portions of data related therewith. Based on such context and/or identified topic, the transfer component 104 can transfer the incoming data communication accordingly. Thus, in this example, the incoming data communication can be transferred and/or directed to at least one physical entity with pre-existing and/or pre-defined knowledge of finances. In particular, the incoming data communication can be transferred and/or directed to a finance department and/or division. Moreover, it is to be appreciated that the incoming data communication can be directed to a plurality of physical entities simultaneously and/or individually with any suitable ordering. For example, the transfer component 104 can direct the incoming data communication to entities with pre-existing knowledge in a particular priority (e.g., Bob is foremost insightful on topic, Jane is next foremost, etc.) or the incoming data communication can be linked to a plurality of entities simultaneously (e.g., Bob and Jane are linked to the communication, etc.).

In addition, the system 100 can include any suitable and/or necessary interface component (not shown), which provides various adapters, connectors, channels, communication paths, etc. to integrate the analyzer component 102 and/or the transfer component 104 into virtually any operating and/or database system(s) and/or with one another. In addition, the interface component can provide various adapters, connectors, channels, communication paths, etc., that provide for interaction with the analyzer component 102, the transfer component 104, and any other device and/or component associated with the system 100.

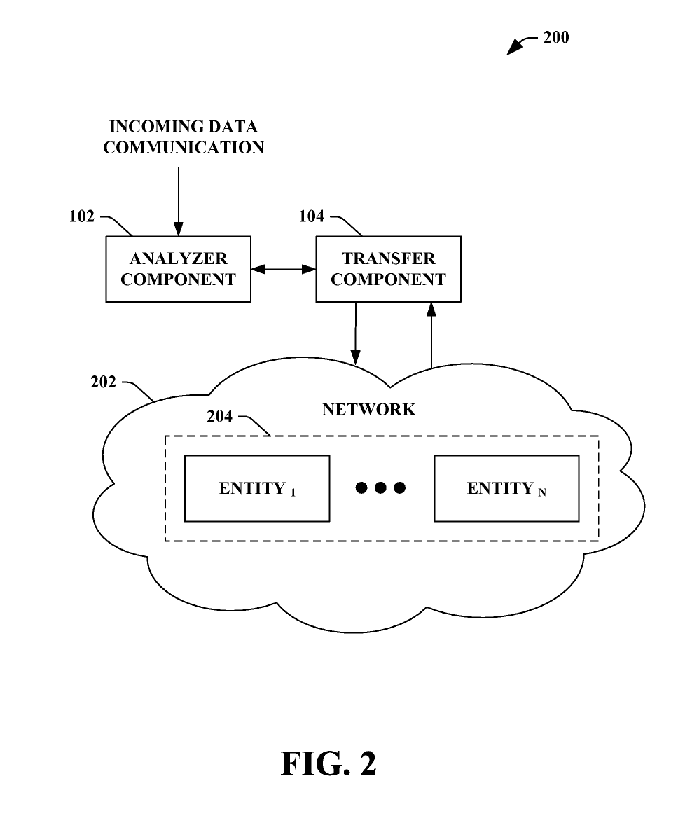

FIG. 2 illustrates a system 200 that facilitates directing an incoming data communication to an entity related to the context of the incoming data communication. The system 200 can include the analyzer component 102 that can evaluate a portion of an incoming data communication in order to ascertain the context, topic, specification, detail, etc. related therewith. For example, the analyzer component 102 can evaluate various aspects and/or data associated with the incoming data communication such as, metadata, incoming data communication origin, time, date, geographic location of source/origin, parsing text, metadata identifying role/context, etc. It is to be appreciated that the analyzer component 102 can evaluate and/or analyze any suitable portion of data related and/or extracted from the incoming data communication in order to construct and/or identify a context, topic, specifics, details, etc. of the incoming data communication.

Based upon the evaluation provided by the analyzer component 102, the transfer component 104 can direct the incoming data communication to at least one entity 204 within a network 202. It is to be appreciated that the network 202 can include any suitable number of entities such as entity 1 to entity N, where N is a positive integer. The entities 204 can be any suitable communicative entity that can include a pre-existing knowledge associated with a topic and/or context that is identified by the analyzer component 102. In particular, the entities 204 can be hardware, software, physical individuals, people, customer service, etc. The entities 204 can also be a group, a division, a subgroup, a branch, a department, etc. that handles and/or has a pre-existing knowledge of the topic and/or context associated with the incoming data communication.

For instance, the network 202 can be any suitable network in which the incoming data communication can target. In other words, the network 202 can be a specific network that is targeted by the incoming data communication and/or the destination of the incoming data communication. In another example, the network 202 can be any suitable network associated with at least one of a business, a company, an enterprise, a home, a household, a commercial property, a residential address, etc. In still another example, the network 202 can be a telecommunication system for communicating and/or sharing resources. In particular, the network 202 can be a network of data processing nodes that can be interconnected for communicating data. It is to be appreciated that there can be any suitable number of networks 202 in which the analyzer component 102 and/or the transfer component 104 can evaluate and transfer incoming data communications. For example, an incoming data communication can be received in connection with a first network, wherein it can be ascertained the context relates to a sub-network and/or disparate network. Based on such details, the incoming data communication can be re-directed by the system 200 to the appropriate network (e.g., the sub-network and/or disparate network). In other words, the system 200 can direct incoming data communications to a plurality of networks, in which the networks can be sub-networks, interconnected networks, disparate networks, shared networks, etc.

For instance, the incoming data communication can be automatically routed to a most appropriate individual among a cluster of individuals associated with a communication. It is to be appreciated a plurality of factors associated with the incoming data communication can be evaluated in order to automatically route and/or direct the communication such as, but not limited to, origination of communication, demographics of a caller/origin, language preference, time of day, priority of communication, status of caller (e.g., high valued customer, high volume consumer, etc.), urgency, stress, notions of irritability or impatience, etc. Such factors can be utilized to properly route and/or direct an incoming data communication to a most appropriate individual for handling. In another example, a customer that originates an incoming data communication can have a strong accent associated with a particular country, wherein the system 200 can direct such communication to a physical entity within the network 202 that speaks the same native language or is of the same culture.

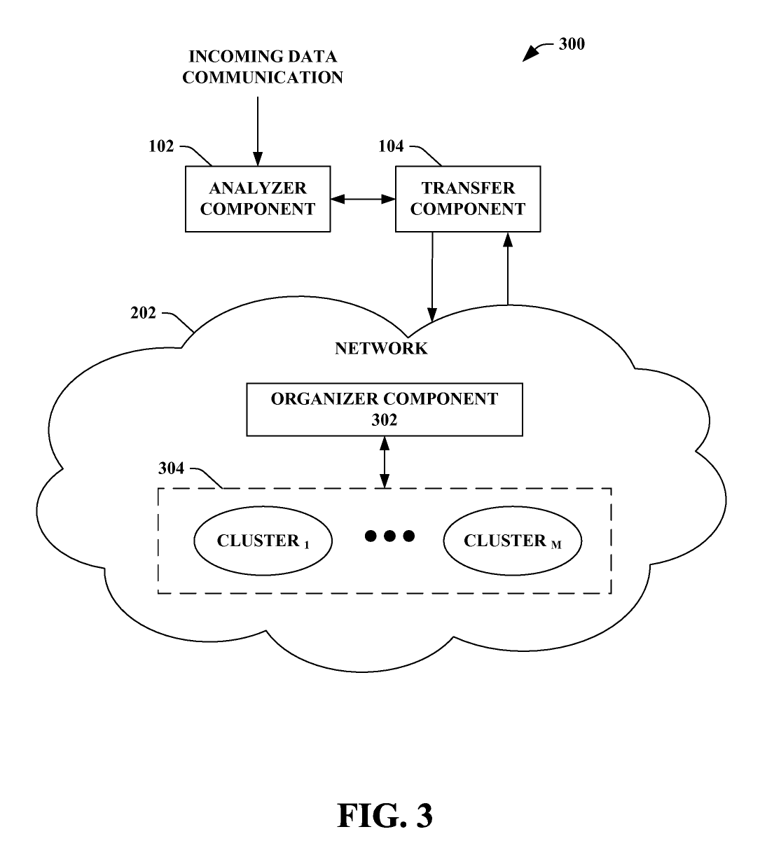

FIG. 3 illustrates a system 300 that facilitates transferring an incoming data communication to a cluster of individuals within a network. The system 300 can include the analyzer component 102 that can identify a context and/or topic related to an incoming data communication. For example, the analyzer component 102 can evaluate portions of data related to the incoming data communication in order to identify a context and/or a topic. Upon identification of a topic and/or a context related to the incoming data communication, the transfer component 104 can direct the incoming data communication to a physical entity that can handle the communication based upon having a pre-existing knowledge of the topic and/or the context. Thus, an incoming data communication can have an identified context related to purchasing goods, wherein the system 300 can direct the incoming data communication to a physical entity with pre-existing knowledge of such topic such as a sales person.

The system 300 can include an organizer component 302 that can evaluate the network 202 in order to generate at least one cluster 304 of entities associated with a particular topic and/or context. The organizer component 302 can evaluate any suitable a device, a component, a machine, a physical entity, an individual, a data transmission (e.g., email data, instant message data, voicemail data, VoIP communication data, cellular communications, text message data, email application data, audio data, office communications, etc.), a portion of metadata within the network, or a portion of hardware, etc. associated with the network 202, in order to generate and/or create clusters 304 based at least in part upon the evaluation. For instance, a server directory can be leveraged by the system 300 in order to identify a context corresponding to a physical entity and/or a cluster. For instance, the server directory can be a central authentication and authorization service for computers. Moreover, the server directory can enable an administrator to assign policies, deploy software, and apply critical updates to an entire organization, wherein such server directory can store information and settings relating to an organization in a central, organized, accessible database. Based on such generated clusters 304, the transfer component 104 can direct incoming data communications. In other words, the organizer component 302 can create clusters 304 with respective topics and/or contexts, in which the transfer component 104 can direct corresponding incoming data communications. For example, the organizer component 302 can identify topics and/or contexts actively, passively, and/or any combination thereof. For instance, the organizer component 302 can actively request information in order to ascertain a topic and/or context associated with an entity (e.g., a physical entity, an individual, etc.) within the network 202. In addition, the organizer component 302 can continuously monitor data and/or data communications associated with the network 202 in order to passively identify contexts and/or topics for clusters 304. In still another example, the organizer component 302 can automatically generate and/or create additional clusters of entities based at least in part upon the routing implemented by the transfer component 104. Thus, if the transfer component 104 directs communications to a group of entities related to a topic/context to which no cluster exists, the organization component 304 can generate such cluster for employment.

For example, a business network can be evaluated and continuously monitored in real time in order to identify specialties, topics, contexts, etc. that correspond to particular entities. Thus, if Bob typically handles incoming data communications related to returning merchandise, future incoming data communications can be transferred and/or directed to Bob based on such evaluation. Moreover, it can be ascertained that a cluster of entities can specialize in a topic, a context, etc., wherein each entity within a cluster can be prioritized (e.g., prioritize members of a cluster, wherein communications are directed to a member with a highest priority first, and so on and so forth). In another example, the incoming data communication can be directed to the members of a cluster simultaneously.

Furthermore, incoming data communications can be parsed and automatically routed to a most appropriate individual for handling. For instance, the system 300 can employ at least one of a filter and/or metadata. A filter and/or metadata can be employed to determine and/or ascertain which individual within a cluster has the strongest correlation with the incoming data communication topic and/or context. Thus, an incoming data communication can be evaluated to identify intent, a goal, a topic, a context, etc., wherein a filter and/or metadata can be utilized to identify a suitable cluster that correlates or corresponds therewith. Moreover, individuals within a cluster can be dynamically masked from the communication as a function of content of the communication, role of the sender, and/or role of the individual within the cluster.

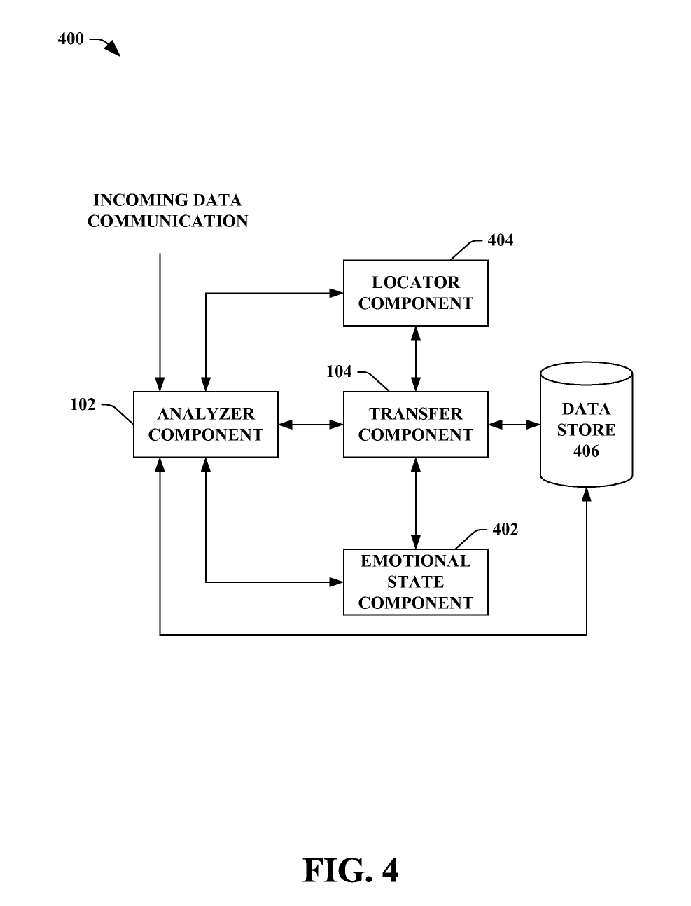

FIG. 4 illustrates a system 400 that facilitates servicing an incoming data communication targeted for a network. The system 400 can include the analyzer component 102 that can identify a context and/or topic related to an incoming data communication. Based at least in part upon the evaluation, the transfer component 104 can direct, route, and/or transfer incoming data communications to a particular cluster of physical entities within a network (not shown). It is to be appreciated that the system 400 can evaluate any suitable portion of data related to a portion of incoming data communication such as, but not limited to, source/origin details (e.g., individual data, geographic origin, etc.), type of incoming communication, time, historic data related to the origin/source (e.g., frequency, transactional data, etc.), etc. Moreover, the transfer component 104 can automatically direct incoming data communications to appropriate entities (e.g., physical individuals with pre-existing knowledge and/or experience in a topic and/or the context) within the network in a dynamic and seamless manner.

The system 400 can include an emotional state component 402 that can monitor a data communication in order to ascertain an emotion, wherein the emotion can be any human emotion such as, but not limited to, irritability, impatience, frustration, anger, happiness, excited, any emotion that can be have a negative impact on a consumer's/customer's opinion, any emotion that can have a positive impact on a consumer's/customer's opinion, etc. It is to be appreciated that the emotional state component 402 can monitor and/or identify such emotions upon initial receipt of an incoming data communication and/or after an incoming data communication has be directed to an identified cluster with pre-existing experience and/or knowledge of a topic/context related to the incoming data communication. In particular, the emotional state component 402 can detect the emotion of an incoming data communication (e.g., the source, individual, originator, etc.) based on the tenor, the tone, voice audio level, sounds of irritation (e.g., signs, deep exhale, etc.), any other detectable data/perceptions related to an incoming data communication. Once such emotions are detected, the emotional state component 402 can re-direct and/or direct the incoming data communication so as to handle such communication (e.g., transfer communication to supervisor, manager, boss, expert, etc.). It is to be appreciated that the emotional state component 402 can further automatically direct the incoming data communication with the transfer component 104 based upon a pre-determined period of time. For instance, if an incoming data communication is not handled and/or directed within a particular amount of time, the emotional state component 402 can flag the incoming data communication as high priority to be directed, routed, handled, etc. Thus, incoming data communications can be directed and/or handled within a reasonable amount of time (e.g., the amount of time determined, pre-defined, etc.).

The system 400 can further employ a locator component 404 that can re-direct an incoming data communication to a comparable entity within a cluster in the event that the initial corresponding entity is unavailable. In other words, the locator component 404 can identify a suitable replacement entity based upon the unavailability of an entity initially identified as having knowledge and/or understanding of the incoming data communication context and/or topic. Furthermore, the locator component 404 can employ a proxy within the cluster to re-route the communication if the primary person/entity is unavailable to immediately handle the incoming data communication.

The system 400 can further include a data store 406 that can include/store any suitable data related to the analyzer component 102, the transfer component 104, the incoming data communication, the network (not shown), an entity, etc. For example, the data store 406 can include, but not limited to including, cluster data (e.g., types, topics, members, number of communications directed therewith, etc.), entity data (e.g., specialties, knowledge, expertise, location, name, employment data, etc.), network data (e.g., entities, devices, components, etc.), incoming data communication data (e.g., origin, origin data, geographic data, mode of communication, voice recognition, voice pattern detection, emotion data, etc.), historic data related to previous data communication transfers, any metadata related to the incoming data communication, any data related to the network (not shown), etc.

It is to be appreciated that the data store 406 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 406 of the subject systems and methods is intended to comprise, without being limited to, these and any other suitable types of memory. In addition, it is to be appreciated that the data store 406 can be a server, a database, a hard drive, a pen drive, an external hard drive, a portable hard drive, and the like.

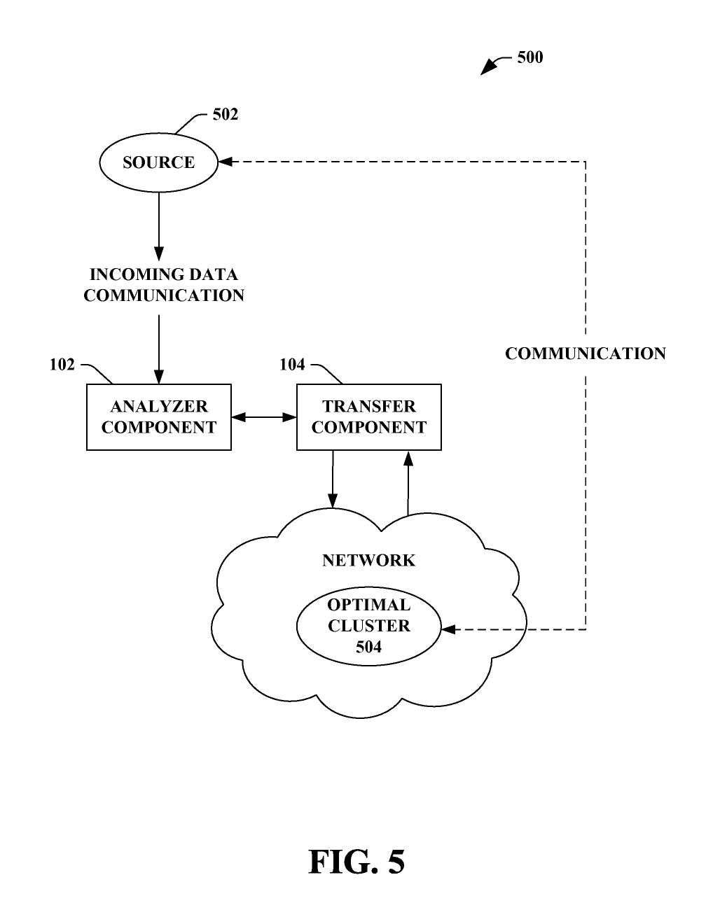

FIG. 5 illustrates a system 500 that facilities linking an incoming data communication from a source to an optimal cluster of individuals that have knowledge of the data communication context. The system 500 can include a source 502 that can initiate an incoming data communication. It is to be appreciated that the source 502 can be any suitable origin of a data communication such as, but not limited to, an individual, a person, a group of people, a business, a company, a home, a resident, a machine, a computer, an automated operator, etc. In addition, the source 502 can initiate the incoming data communication utilizing any suitable data communication device or application such as, but not limited to, a phone, a telephone, a cellular device, a mobile communication device, a machine, a computer, a personal computer, a laptop, a hand-held device, a smartphone, a tablet PC, a text messaging device, an instance messaging component, a portion of software, a portion of hardware, an email application, a voice over Internet protocol (VoIP) communication device, etc.

The source 502 can initiate the incoming data communication with a particular topic and/or context associated therewith. The analyzer component 102 can receive such incoming data communication and identify such particular topic and/or context evaluating various portions of data related therewith (discussed above). Upon identifying the context and/or topic associated with the incoming data communication, the transfer component 104 can locate/identify and direct the incoming data communication to an optimal cluster 504, wherein the optimal cluster 504 can correspond and/or relate to the topic/context. The optimal cluster 504 can be the corresponding cluster to direct the incoming data communication based at least in part upon the optimal cluster 504 including at least one physical entity (e.g., individual, etc.) with pre-existing experience and/or knowledge associated with the topic/context of the incoming data communication. Once the transfer component 104 employs the pairing of the incoming data communication with the optimal cluster 504, the source 502 can be linked, directed, routed, transferred, etc. to the optimal cluster 504 for a communication. The communication between the source 502 and the optimal cluster 504 includes a matching and/or pairing based upon the topic and/or context of the incoming data communication which can enhance and optimize servicing incoming data communications.

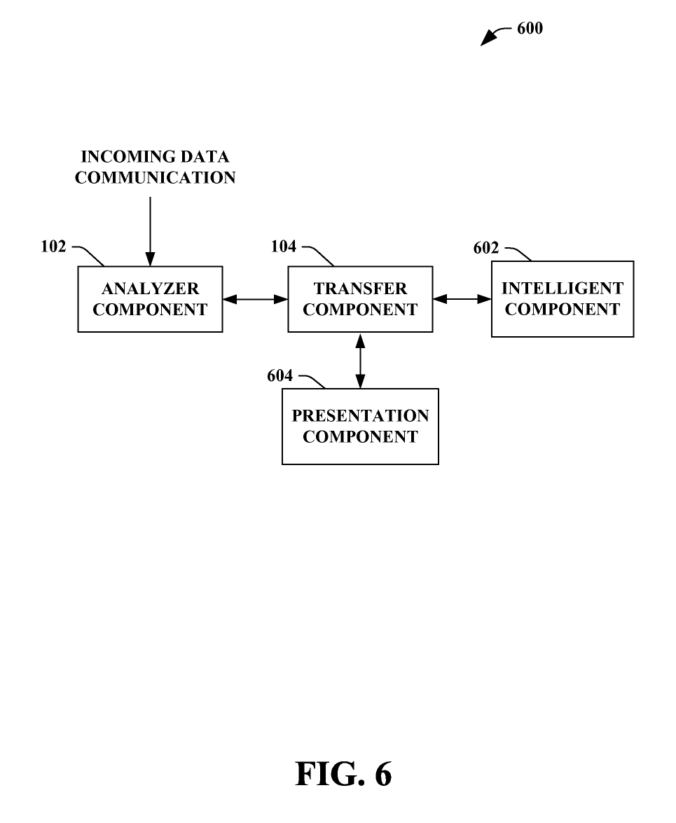

FIG. 6 illustrates a system 600 that employs intelligence to facilitate directing incoming data communications to a knowledgeable resource/entity with efficiency, accuracy, and promptness. The system 600 can include the analyzer component 102, the transfer component 104, and/or the incoming data communication. It is to be appreciated that the analyzer component 102, the transfer component 104, and/or the incoming data communication can be substantially similar to respective components, and communications described in previous figures. The system 600 further includes an intelligent component 602. The intelligent component 602 can be utilized by the analyzer component 102 and/or the transfer component 104 to facilitate servicing incoming data communications in which communications are directed to specialized entities. For example, the intelligent component 602 can infer incoming data communication context and/or topic, origin/source data, cluster data, cluster/entity topic and/or context specialty, cluster and/or entity pre-existing knowledge, origin/source of communication, data surrounding origin/source, network data, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The analyzer component 102 and/or the transfer component 104 can further utilize a presentation component 604 that provides various types of user interfaces to facilitate interaction between a user and any component coupled to the analyzer component 102 and/or the transfer component 104. As depicted, the presentation component 604 is a separate entity that can be utilized with the analyzer component 102 and/or the transfer component 104. However, it is to be appreciated that the presentation component 604 and/or similar view components can be incorporated into the analyzer component 102, the transfer component 104 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the analyzer component 102 and/or the transfer component 104.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

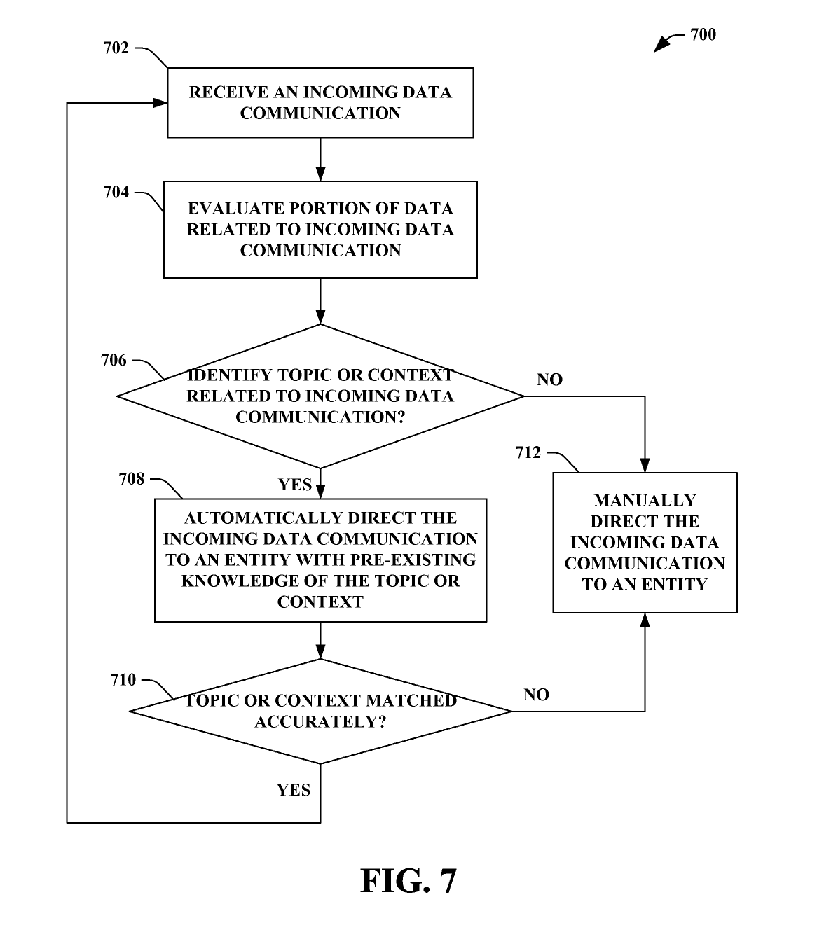

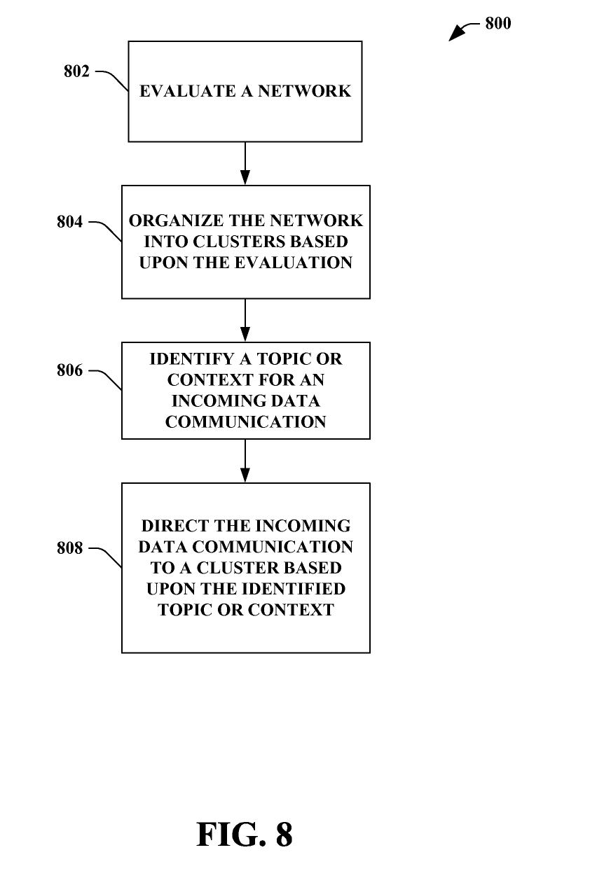

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates servicing incoming data communications. At reference numeral 702, an incoming data communication can be received. For instance, the incoming data communication can be, but is not limited to being, a cellular communication, a telephone communication, a text message, an instant message, an email, a voice mail, an audio communication, a video communication, a voice over Internet protocol (VoIP) communication, a short message service (SMS), a multimedia messaging service (MMS), a voice communication, a data transmission, an image communication, and/or any suitable incoming data communication that can be targeted to a data communication network.

At reference numeral 704, a portion of data related to the incoming data communication can be evaluated. For example, various aspects and/or data associated with the incoming data communication can be evaluated such as, metadata, incoming data communication origin, time, date, demographics of a caller/origin, language preference, geographic location of source/origin, parsing text, metadata identifying role/context, priority of communication, status of caller (e.g., high valued customer, high volume consumer, etc.), urgency, stress, notions of irritability or impatience, etc. Yet, it is to be appreciated that any suitable portion of data related and/or extracted from the incoming data communication can be evaluated in order to construct and/or identify a context, topic, specifics, details, etc. of the incoming data communication.

At reference numeral 706, a determination whether a topic and/or context related to the incoming data communication has been identified based can be made. If a topic and/or context related to the incoming data communication has not been identified, the methodology 700 continues to reference numeral 712. However, if a topic and/or context related to the incoming data communication has been identified based on the evaluation, the methodology 700 can continue to reference numeral 708. At reference numeral 708, the incoming data communication can be automatically directed to an entity with pre-existing knowledge of the identified topic and/or context. At reference numeral 710, a determination whether the topic or context was matched accurately can be made. If the topic/context was not matched accurately, the methodology 700 can continue to reference numeral 712. At reference numeral 712, the incoming data communication can be manually routed and/or directed to an entity. It is to be appreciated that the manual routing and/or directing can be based on a default ranking of entities, a ranking preference, a best-effort matching among viable alternatives, etc. If the topic/context was matched accurately, the methodology 700 can continue at reference numeral 702 to receive an incoming data communication (e.g., to evaluate and/or transfer, etc.).

FIG. 8 illustrates a method 800 for directing an incoming data communication to an entity related to the context of the incoming data communication. At reference numeral 802, a network can be evaluated. The network can be any suitable network associated with a business, a company, an enterprise, a home, a household, a commercial property, a residential address, etc. The network, in general, can be a telecommunication system for communicating and/or sharing resources. In other words, the network can be a network of data processing nodes that can be interconnected for communicating data. The network can include at least one entity, wherein the evaluation can identify a topic, context, etc. to which entities are experienced and/or have knowledge. For instance, any suitable device, entity, component, individual, etc. associated with the network can be evaluated

At reference numeral 804, the network can be organized into clusters based at least in part upon the evaluation of the network. Thus, the identified topics, contexts, etc. and corresponding entities can be grouped into clusters. In other words, the clusters with respective topics and/or contexts can be created based on evaluating the network and respective data. For example, the network can be evaluated actively, passively, and/or any combination thereof. In one example, active requests for information can be transmitted in order to ascertain a topic and/or context associated with an entity (e.g., a physical entity, an individual, etc.) within the network. In particular, a questionnaire can be transmitted to entities within a network in order to identify topics/context in which there is pre-existing knowledge. In addition, the network, data, and/or data communications can be continuously monitored in order to passively identify contexts and/or topics for clusters.

At reference numeral 806, a topic and/or context can be identified for an incoming data communication targeted for the network. The incoming data communication can be any suitable communication targeted to the network, wherein data associated with the data communication can be evaluated in order to identify a context and/or topic to which the incoming data communication relates. At reference numeral 808, the incoming data communication can be directed to a cluster based at least in part upon the identified topic and/or context. By routing and/or directing the incoming data communication to the cluster with corresponding knowledge of the topic/context, servicing communications is enhanced and optimized. It is to be appreciated that the methodology 800 can utilize a preference ranking or a default option in the event of two or more clusters having equal weight for a given communication. In other words, if two or more clusters are tied (e.g., equally weighted), the methodology 800 can employ a preference ranking or a default setting to identify the cluster routing.

For example, a customer can use a telephone to contact a phone company (e.g., a network), to request changes to telephone service. The incoming data communication (e.g., the telephone call) can be evaluated by evaluating data (e.g., call origin, time of day, voice/speech data, linguistics, data mode/type, etc.) related to the data communication in order to identify the topic/context as a request to change existing telephone service. Once identified, the incoming data communication can be directed to an entity and/or a cluster of entities that have pre-existing knowledge of the topic/context.

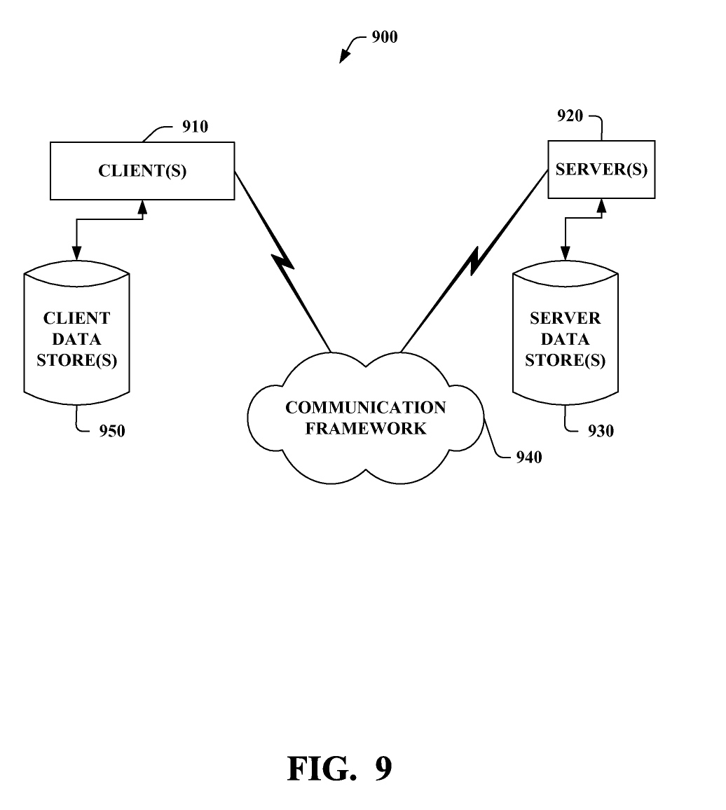

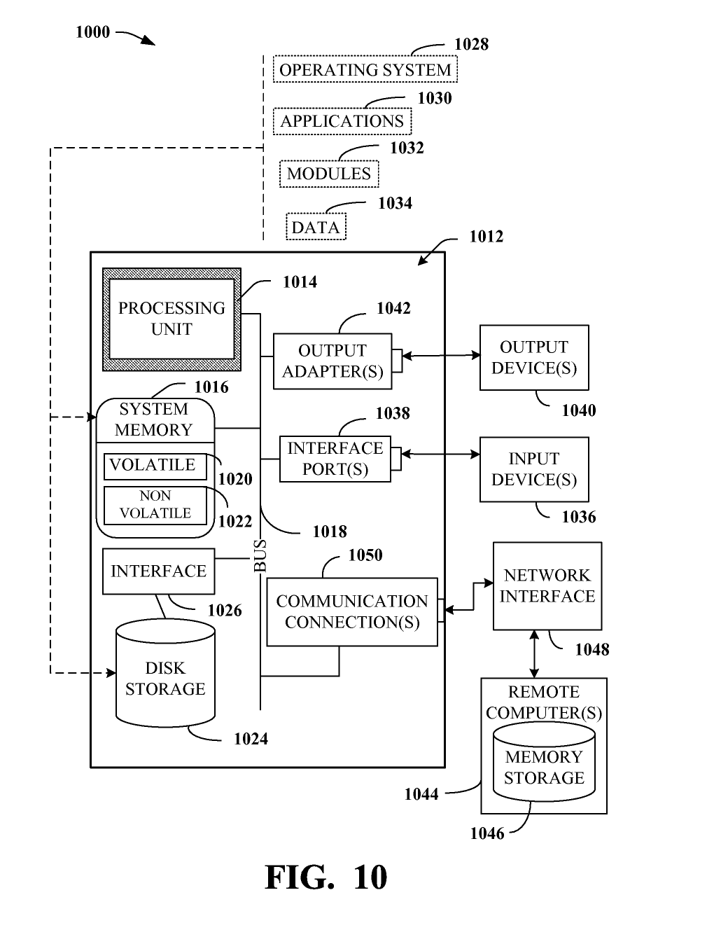

In order to provide additional context for implementing various aspects of the claimed subject matter, FIGS. 9-10 and the following discussion is intended to provide a brief, general description of a suitable computing environment in which the various aspects of the subject innovation may be implemented. For example, an analyzer component can evaluate incoming data communications to enable a transfer component to direct the incoming communication based on contextual evaluation, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 9 10. Similarly, the server(s) 920 are operably connected to one or more server data store(s) 930 that can be employed to store information local to the servers 920. It is to be appreciated that there can be a single data store in which the data stores can communicate directly with one another.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates enhancing incoming data communication connectivity within a network, comprising:
an analyzer component that evaluates a portion of an incoming data communication targeted for a network to identify a context associated with the data communication; and
a transfer component that directs the incoming data communication to a cluster within the network based at least in part upon the identified context, the cluster includes a physical entity with pre-existing knowledge of the identified context.

2. The system of claim 1, the incoming data communication relates to at least one of a cellular communication, a telephone communication, a text message, an instant message, an email, a voice mail, an audio communication, a video communication, a voice over Internet protocol (VOIP) communication, a short message service (SMS), a multimedia messaging service (MMS), a voice communication, a data transmission, or an image communication.

3. The system of claim 1, the network is associated with at least one of a business, a company, an enterprise, a home, a household, a commercial property, a private location, a public location, or a residential address.

4. The system of claim 3, the network is a telecommunication system for at least one of communicating a resource or sharing a resource by employing a network of data processing nodes that are interconnected therewith.

5. The system of claim 1, the analyzer component evaluates a portion of data related to the incoming data communication to ascertain the context, the portion of data relates to at least one of an incoming data communication origin, an incoming data communication time, an incoming data communication date, a geographic location of a source of the incoming data communication, a parsed portion of data related to the incoming data communication, a portion of parsed text, a portion of parsed audio, or a portion of parsed video.

6. The system of claim 5, the portion of data relates to at least one of a portion of metadata identifying a role associated with the source of the incoming data communication, a demographic of a source, a language preference of the incoming data communication, a priority of the incoming data communication, a status of caller, a voice pattern characteristic, data reflecting an emotion of the incoming data communication, a type of incoming data communication, a portion of historic data related to the source, a portion of historic data related to the incoming data communication, a voice recognition, a voice pattern detection, or a portion of metadata related to the incoming data communication.

7. The system of claim 1, the analyzer utilizes at least one of a filter or a portion of metadata related to the incoming data communication to identify the context therewith.

8. The system of claim 1, further comprising an organizer component that generates at least one cluster including the physical entity associated with the network.

9. The system of claim 8, the organizer component evaluates a portion of data related to the network and at least one physical entity to generate the cluster.

10. The system of claim 9, the organizer component evaluates a portion of the network including at least one of a device, a component, a machine, a physical entity, an individual, a data transmission, a portion of an email, a portion of a voicemail, a portion of a text message, a portion of an instant message, a contact list related to email, a cellular communication, a voice over Internet protocol (VOIP) communication, a portion of metadata within the network, or a portion of hardware.

11. The system of claim 9, the organizer component leverages a server directory to identity at least one pre-existing knowledge for the physical entity within the network.

12. The system of claim 9, the organizer component prioritizes each physical entity within the cluster based upon amount of pre-existing knowledge of the context, the transfer component directs the incoming data communication utilizing the prioritization created by the organizer component.

13. The system of claim 1, the transfer component directs the incoming data communication to a plurality of physical entities in a cluster with pre-existing knowledge of the context simultaneously.

14. The system of claim 1, further comprising an emotional state component that monitors the incoming data communication for an emotional characteristic that impacts a source of the incoming data communication, the emotional characteristic is identified by at least one of a voice recognition, a voice pattern recognition, an audio evaluation, a tenor, a tone, a voice audio level, a sound of irritation, a sign, or a deep exhale.

15. The system of claim 1, the analyzer component is trained by at least one of an end-user, a disparate analyzer, a portion of historic data, a local area analyzer component on a network, an organization of analyzer components, or an intelligent component.

16. The system of claim 1, further comprising a locator component that re-directs the incoming data communication to a disparate physical entity within the cluster in based on an initially directed physical entity being unavailable.

17. A computer-implemented method that facilitates efficiently servicing an incoming data communication, comprising:
receiving an incoming data communication;
evaluating a portion of data related to the incoming data communication;
identifying a context related to the incoming data communication based upon the evaluation; and
automatically directing the incoming data communication to a physical entity within a cluster, the cluster includes physical entities with a pre-existing knowledge of the context of the incoming data communication.

18. The method of claim 17, further comprising:
evaluating a portion of data related to the network; and
organizing the network into clusters based upon the evaluation.

19. The method of claim 17, the incoming data communication relates to at least one of a cellular communication, a telephone communication, a text message, an instant message, an email, a voice mail, an audio communication, a video communication, a voice over Internet protocol (VOIP) communication, a short message service (SMS), a multimedia messaging service (MMS), a voice communication, or a data transmission, an image communication.

20. A computer-implemented system that facilitates enhancing incoming data communication connectivity within a network, comprising:
means for evaluating a portion of an incoming data communication targeted for a network to identify a context associated with the data communication; and
means for directing the incoming data communication to a cluster within the network based at least in part upon the identified context, the cluster includes a physical entity with pre-existing knowledge of the identified context.
